(19) United States
(12) Patent Application Publication
(10) Pub. No.: US 2023/0028145 A1
(43) Pub. Date: Jan. 26, 2023

(54) INFORMATION PROCESSING DEVICE, REWARD DETERMINATION METHOD, AND STORAGE MEDIUM

(71) Applicant: TOYOTA JIDOSHA KABUSHIKI KAISHA, Aichi-ken (JP)

(72) Inventors: Masato ENDO, Nagoya-shi (JP); Yasuyuki KAMEZAKI, Toyota-shi (JP); Yasuhiro MURATA, Toyota-shi (JP); Takeo MORIAI, Nagakute-shi (JP); Kosuke SAKAKIBARA, Toyota-shi (JP); Kenta MIYAHARA, Okazaki-shi (JP); Takashi HAYASHI, Nagoya-shi (JP)

(21) Appl. No.: 17/847,087

(22) Filed: Jun. 22, 2022

(30) Foreign Application Priority Data
Jul. 26, 2021 (JP) 2021-122025

(51) Int. Cl. G06Q 30/02

(52) U.S. Cl. CPC G06Q 30/0231

(57) ABSTRACT

A center server serving as an information processing device is configured such that a processor calculates a reduction cost by which an operation cost of a vehicle of a business operator in a first predetermined period is reduced compared to an operation cost of a vehicle of the same period of a previous year, sets a rank in accordance with a reduction result of each of the members regarding the reduction cost, and determines a reward of the member based on the reduction cost in accordance with the rank of the member.

### CROSS-REFERENCE TO RELATED APPLICATION

This application claims priority to Japanese Patent Application No. 2021-122025 filed on Jul. 26, 2021, incorporated herein by reference in its entirety.

### BACKGROUND

### 1. Technical Field

The present disclosure relates to an information processing device, a reward determination method, and a storage medium that grant a reward for a vehicle operation.

### 2. Description of Related Art

Japanese Unexamined Patent Application Publication No. 2017-116995 (JP 2017-116995 A) proposes a safe driving recommending system in which a driving behavior detection unit of a terminal detects the driving time and driving behavior of each vehicle, and a server rewards a driver based on the driving behavior during the driving state.

On the other hand, businesses having a plurality of vehicles have a desire to reduce vehicle operation costs (for example, vehicle insurance premiums, repair costs, damage compensation amounts, etc.).

By converting the above safe driving recommendation system, it is conceivable to motivate the user (driver) of the vehicle to drive safely and reduce the operation cost of the vehicle.

### SUMMARY

However, the above-mentioned safe driving recommendation system gives a reward to the driver in accordance with the driving behavior of the driver, and for example, was not something that gives motivation regarding the behavior of the entire business office of a business operator having a plurality of vehicles.

In addition, the safe driving of the individual driver and the reduction amount of the vehicle operation cost of the business operator are not always proportional, and there is a possibility that the reward for the driver will be a burden on the business operator.

Thus, there is a need for an appropriate reward determination method for reducing vehicle operation costs for the business operation that owns the vehicles.

It is an object of the present disclosure to provide an information processing device, a reward determination method, and a storage medium that determine a reward of a user so as to promote reduction of vehicle operation cost.

An information processing device according to a first aspect of the present disclosure includes a processor. The processor includes a calculation unit that obtains an operation cost of a vehicle in a first predetermined period in a group to which a plurality of members who uses the vehicle belong, and that calculates a reduction cost by which the operation cost of the vehicle in the first predetermined period is reduced compared to an operation cost of the vehicle in a second predetermined period that corresponds to the first predetermined period before the first predetermined period, a setting unit that sets a rank in accordance with a reduction result of each of the members, and a determination unit that determines a reward of each of the members based on the reduction cost in accordance with the rank of each of the members.

In the information processing device of the first aspect, the processor (calculation unit) obtains the operation cost of the vehicle of the first predetermined period of the group to which the members who use the vehicle belong, and calculates the reduction cost in which the operation cost of the vehicle in the first predetermined period is reduced as compared with the operation cost of the vehicle in the second predetermined period that corresponds to the first predetermined period before the first predetermined period. In addition, the processor (setting unit) determines the rank in accordance with the reduction result of each member of the group based on the reduction cost, and (the determination unit) determines the reward of the member based on the reduction cost in accordance with the rank of the member.

In other words, since the member is granted with the reward in accordance with a contribution degree (rank) to the reduction of the operation cost of the vehicle of the entire group, it is expected that the member will work hard to reduce the operation cost of the vehicle that they use.

In addition, since the reward of the member is based on the reduction amount (reduction cost) of the vehicle operation cost of the entire group, the member becomes interested in the reduction cost of the entire group.

Thus, efforts will be made to increase the reduction cost not only for each individual member of the group but also for the entire group. For example, it is expected that the member advises other members about driving and maintenance, and that the member proposes to the business operator regarding the reduction of the operation cost of the vehicle.

As a result, the reduction of operation costs of vehicles of the entire group is promoted.

In the first aspect, the determination unit may set the reward to a predetermined amount corresponding to the reduction cost or a predetermined ratio of the reduction cost.

According to the information processing device having the above configuration, since the reward of the member is the predetermined amount corresponding to the reduction cost of the entire group or the predetermined ratio of the reduction cost, the member becomes interested in reducing the operation cost (reduction cost) of the vehicle of the entire group.

In the first aspect, the determination unit may set a reward of a member having a high rank to a predetermined ratio of the reduction cost and may set a reward of a member having a low rank to a predetermined amount.

According to the information processing device having the above configuration, while the reward of the member with a high rank, that is, the member who has a high contribution degree to the reduction of the operation cost of the vehicle, is set as the predetermined ratio (commission) of the reduction cost, the reward of the member with the low rank is set as the predetermined amount (fixed amount).

Thus, it can be expected that the motivation of the member at the high rank to reduce the operation cost of the vehicle can be further improved, and that the motivation of the member at the low rank to reduce the operation cost of the vehicle can be improved in order to improve the rank.

The information processing device may further include a transmitting unit that transmits information of the rank of the member to a terminal of the member.

According to the information processing device having the above configuration, the processor transmits the information of the rank of each member to the terminal of the member. Thus, since the members can confirm their own rank by the terminal, it is expected that they will strive to reduce the operation cost of the vehicle in order to improve the rank (to increase the reward).

In the reward determination method according to a second aspect of the present disclosure, a computer executes processes including: obtaining an operation cost of a vehicle in a first predetermined period in a group to which a plurality of members who uses the vehicle belong, and calculating a reduction cost by which the operation cost of the vehicle in the first predetermined period is reduced compared to an operation cost of the vehicle in a second predetermined period that corresponds to the first predetermined period before the first predetermined period; setting a rank in accordance with a reduction result of each of the members; and determining a reward of each of the members based on the reduction cost in accordance with the rank of each of the members.

In the second aspect, the computer calculates the reduction cost in which the operation cost of the vehicle of the first predetermined period in the group is reduced as compared with the operation cost of the operation cost of the vehicle of the second predetermined period that corresponds to the first predetermined period, sets the rank in accordance with a reduction result of each of the members of the group, and determines a reward of each of the members based on the reduction cost in accordance with the rank of the member.

In other words, since the member is granted with the reward in accordance with a contribution degree (rank) of each of the members to the reduction cost of the entire group, it is expected that the member will work hard to reduce the operation cost of the vehicle that they use.

In addition, since the reward of the member is based on the reduction amount (reduction cost) of the vehicle operation cost of the entire group, the member becomes interested in the reduction cost of the entire group.

Thus, efforts will be made to increase the reduction cost not only for each individual member of the group but also for the entire group. For example, it is expected that the member advises other members about driving and maintenance, and that the member proposes to the business operator regarding the reduction of the operation cost of the vehicle.

As a result, the reduction of operation costs of vehicles of the entire group is promoted.

A storage medium according to a third aspect of the present disclosure stores a reward determination program that causes a computer to execute processes including: obtaining an operation cost of a vehicle in a first predetermined period in a group to which a plurality of members who uses the vehicle belong, and calculating a reduction cost by which the operation cost of the vehicle in the first predetermined period is reduced compared to an operation cost of the vehicle in a second predetermined period that corresponds to the first predetermined period before the first predetermined period; setting a rank in accordance with a reduction result of each of the members; and determining a reward of each of the members based on the reduction cost in accordance with the rank of each of the members.

In the third aspect, the storage medium provides the reward to the member of the group based on the reduction cost reduced in the operation cost of the vehicle of the entire group, and causes the computer to perform the following processes. That is, the computer calculates the reduction cost in which the operation cost of the vehicle of the first predetermined period in the group is reduced as compared with the operation cost of the operation cost of the vehicle of the second predetermined period that corresponds to the first predetermined period, sets the rank in accordance with a reduction result of each of the members of the group, and determines a reward of each of the members based on the reduction cost in accordance with the rank of the member.

According to the storage medium, since the member is granted with the reward in accordance with a contribution degree (rank) of each of the members to the reduction cost of the entire group, it is expected that the member will work hard to reduce the operation cost of the vehicle that they use.

In addition, since the reward of the member is based on the reduction amount (reduction cost) of the vehicle operation cost of the entire group, the member becomes interested in the reduction cost of the entire group.

Thus, efforts will be made to increase the reduction cost not only for each individual member of the group but also for the entire group. For example, it is expected that the member advises other members about driving and maintenance, and that the member proposes to the business operator regarding the reduction of the operation cost of the vehicle.

As a result, the reduction of operation costs of vehicles of the entire group is promoted.

According to the present disclosure, each of the members that configure the group becomes interested in reducing the operation cost of the vehicle of the entire group, and the reduction of the operation cost of the vehicle of the entire group is promoted.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a reward system according to an embodiment;

FIG. 2 is a block diagram showing a hardware configuration of a center server according to the embodiment;

FIG. 3 is a block diagram showing a functional configuration of the center server according to the embodiment;

FIG. 4 is a flowchart showing a flow of a reward determination process executed in the center server according to the embodiment;

FIG. 5 is a diagram illustrating operation costs information of a vehicle stored in a total cost DB;

FIG. 6 is a diagram illustrating a total cost compared with the same period of the previous year, and a reduction cost; and

FIG. 7 is a diagram showing the relationship between the operation cost of each vehicle, an increase/decrease rate, and a rank of a user of the vehicle.

### DETAILED DESCRIPTION OF EMBODIMENTS

A reward system including an information processing device according to an embodiment will be described. Based on a reduction amount (reduction cost) of a vehicle operation cost of an entire group having a plurality of members who use the vehicle, the reward system determines the reward for the members.

In the present embodiment, the group is a business operator who owns a plurality of vehicles, and the members are users (employees) who drive the vehicles of the business operator (company). For example, the business operator is a taxi company, the vehicle is a taxi, and the members are taxi drivers.

Overall Structure

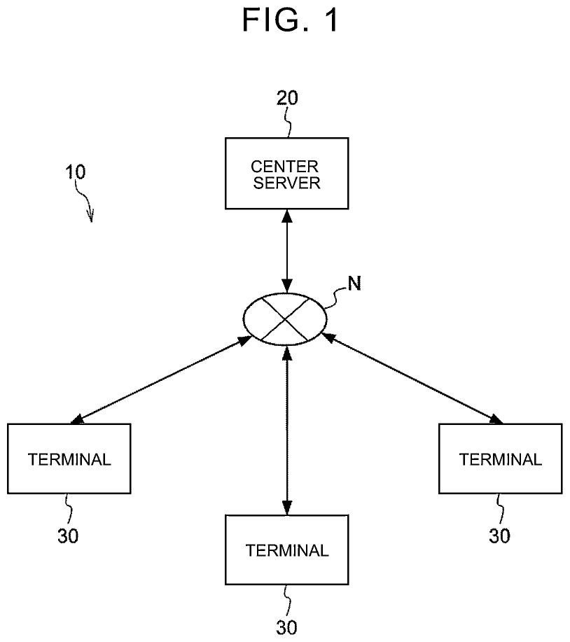

As shown in FIG. 1, a reward determination system 10 according to the present embodiment includes, a center server 20 of a business operator in which center server 20 serves as an information processing device, and a terminal 30 of a vehicle user. The center server 20 and the terminal 30 are connected to each other through a network N. Although FIG. 1 shows three terminals 30 for one center server 20, the number of terminals 30 is not limited to this.

Further, the center server 20 is installed in, for example, a business office of a business operator. The terminal 30 is owned (carried) by an employee (user) of a business operator who drives a vehicle.

Center Server

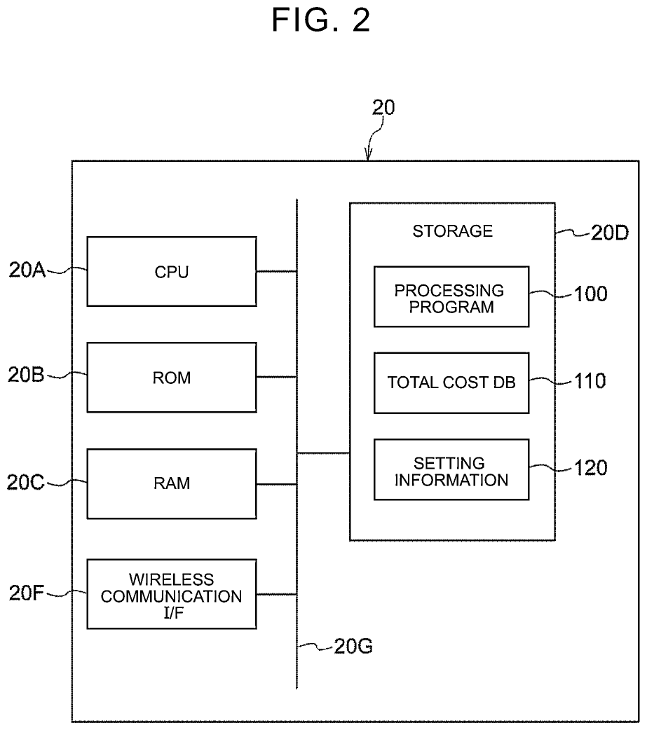

As shown in FIG. 2, the center server 20 according to the present embodiment is configured to include a central processing unit (CPU) 20A, a read-only memory (ROM) 20B, a random access memory (RAM) 20C, a storage 20D, and a wireless communication interface (I/F) 20F. The CPU 20A, the ROM 20B, the RAM 20C, the storage 20D, and the wireless communication I/F 20F are connected so as to be able to communicate with each other via an internal bus 20G.

The CPU 20A is a central processing unit that executes various programs and controls various units. That is, the CPU 20A reads the program from the ROM 20B and executes the program using the RAM 20C as a work area.

The ROM 20B stores various programs and various data.

The RAM 20C temporarily stores a program or data as a work area.

The wireless communication I/F 20F is a wireless communication module for communicating with the terminal 30. For the wireless communication module, for example, communication standards such as 5th Generation (5G), long term evolution (LTE), and Wi-Fi (registered trademark) are used. The wireless communication I/F 20F is connected to the network N.

The storage 20D is composed of a hard disk drive (HDD) or a solid state drive (SSD), and stores various programs and various data. The storage 20D of this embodiment stores a processing program 100, a total cost database (DB) 110, and setting information 120.

The program 100 serving as a reward determination program is a program for controlling the center server 20. With the execution of the processing program 100, the center server 20 calculates or reads an operation cost (total cost) of all vehicles in a predetermined period of the operator, calculates an amount in which the total cost was reduced (reduction cost) in the predetermined period compared to the total cost in the same period of the previous year, sets the user's rank in accordance with the user's contribution to the reduction cost, determines the reward of the user based on the reduction cost in accordance with the rank of the user, and transmits the rank and the like to the terminal of the user.

As shown in FIG. 5, the total cost DB 110 is a database in which the vehicle operation cost (insurance premium, repair cost, damage compensation amount) for each vehicle for a predetermined period (for example, every fiscal year, quarterly, etc.), and the total vehicle operation cost for all vehicles (total cost) are stored.

The reward rate and the like in accordance with the rank, in which the reward rate is used when obtaining the reward of each user, when the total cost of the predetermined period of the current fiscal year is reduced as compared with the total cost of the predetermined period of the previous fiscal year is stored in the setting information 120.

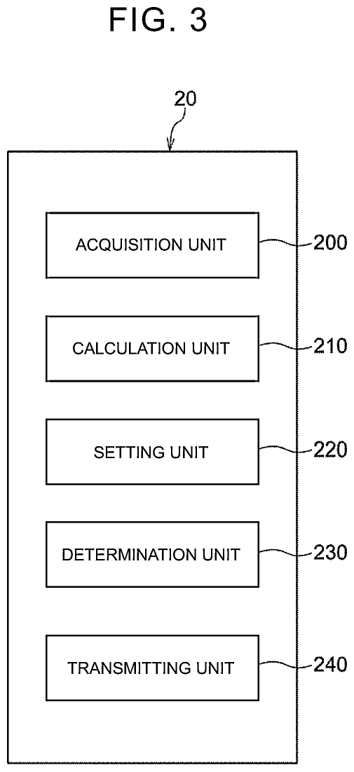

As shown in FIG. 3, in the center server 20 according to the present embodiment, the CPU 20A functions as an acquisition unit 200, a calculation unit 210, a setting unit 220, a determination unit 230, and a transmitting unit 240, by executing the processing program 100.

The acquisition unit 200 has a function of acquiring the total cost in the predetermined period of the current fiscal year from the total cost DB 110 and acquiring the total cost of the same period of the previous year, at regular or arbitrary timings.

The calculation unit 210 has a function of subtracting the total cost of the same period of the previous year (for example, 2019) from the total cost of the predetermined period of the current year (for example, 2020) acquired by the acquisition unit 200, and determining whether the total cost of the predetermined period of the current year is reduced based on the difference is negative or not.

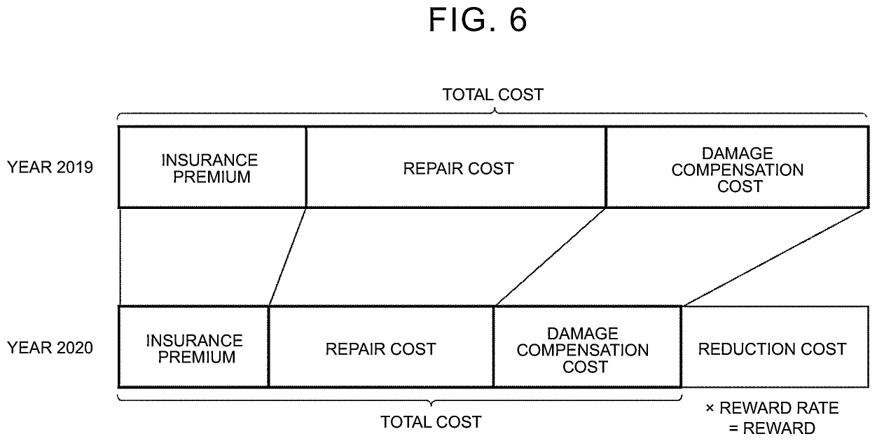

As shown in FIG. 6, when the total cost is reduced, the calculation unit 210 calculates the difference as the reduction cost.

The setting unit 220 has a function of setting the contribution degree (rank) of each vehicle (user of the vehicle) with respect to the reduction amount (reduction cost) of the total cost, when the total cost of the predetermined period of the current year is reduced as compared with the total cost of the same period of the previous year.

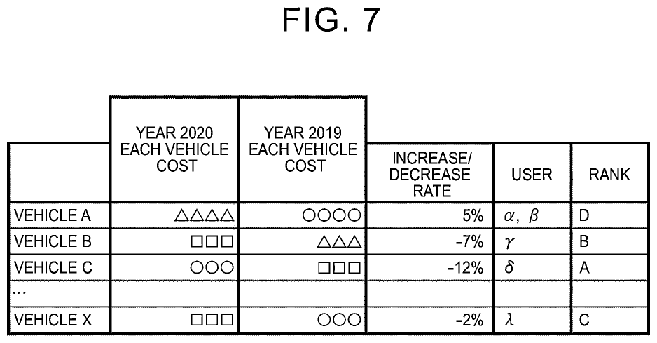

Specifically, the vehicle operation cost of the predetermined period of the current year for each vehicle (hereinafter referred to as “each vehicle cost”) and each vehicle cost of the same period of the previous year are acquired from the total cost DB 110, and the increase/decrease rate in each vehicle cost of the current year to each vehicle cost in the same period of the previous year is calculated, and the rank of the user of the vehicle is set in accordance with the increase/decrease rate (see FIG. 7).

For example, as shown in FIG. 7, the user of the vehicle in which the vehicle cost is reduced by 10% or more compared to the same period of the previous year is set as a rank A, the user of the vehicle in which the vehicle cost is reduced by 5% or more and less than 10% is set as a rank B, the user of the vehicle in which the vehicle cost is reduced by less than 5% is set as a rank C, and the user of the vehicle in which the cost of each vehicle is not increased/decreased is set as a rank D.

Further, the setting unit 220 has a function of setting the reward rate for each rank based on the setting information 120. For example, the reward rate of rank A is set to 3%, the reward rate of rank B is set to 1%, the reward rate of rank C is set to 0.5%, and the reward rate of rank D is set to 0%.

The determination unit 230 has a function of determining the reward of the user based on the reduction cost in accordance with the rank of each user, when the total cost of the business operator is reduced.

For example, the amount obtained by multiplying the reduction cost of the total cost of the business operator (see FIG. 6) by the reward rate set in accordance with the rank of each user is calculated, and the amount is determined as the reward of the user.

The transmitting unit 240 transmits rank information and reduction cost information from the center server 20 to the user's terminal 30 via the network N.

At this time, as for the transmitted information, the individual rank and the reduction cost are transmitted as information.

Flow of Control

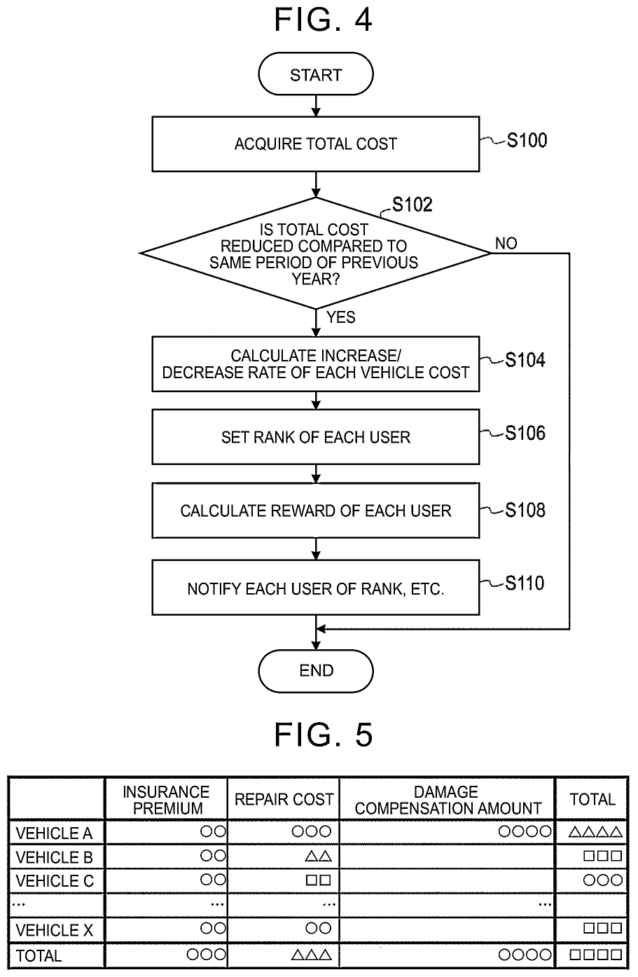

In the present embodiment, the flow of the reward determination process executed by the center server 20 when determining the reward for each user for the reduction of the total cost will be described with reference to the flowchart of FIG. 4. This process is executed, at a predetermined timing or periodically, by the CPU 20A of the center server 20 functioning as the acquisition unit 200, the calculation unit 210, the setting unit 220, the determination unit 230, and the transmitting unit 240.

The CPU 20A acquires the total cost information of the business operator of the predetermined period of the current fiscal year of the business operator from the total cost DB 110, and also acquires the total cost information of the same period of the previous year (FIG. 4, step S100 (hereinafter, the term “FIG. 4” is omitted)).

In step S102, the CPU 20A determines whether the total cost of the predetermined period of the current year is reduced as compared with the total cost of the same period of the previous year (step S102). Specifically, the CPU 20A determines whether the value obtained by subtracting the total cost of the same period of the previous year from the total cost of the predetermined period of the current year becomes negative.

When the total cost is not reduced in step S102 (NO in step S102) (when the subtracted value is positive or 0), the CPU 20A ends the process.

On the other hand, when the total cost is reduced (YES in step S102) (when the above subtracted value is negative), as shown in FIG. 7, the CPU 20A acquires each vehicle cost of the predetermined period of the current year (for example, 2020) of each vehicle from the total cost DB 110, and also each vehicle cost of the same period of the previous year (for example, 2019) is acquired, and the increase/decrease rate of each vehicle cost in the same period of the previous year is calculated for each vehicle (step S104).

Subsequently, the CPU 20A sets the rank (see FIG. 7) indicating the contribution degree of the user of each vehicle with respect to the reduction cost, based on the increase/decrease rate of each vehicle cost (step S106).

For example, compared to the same period of the previous year, when the increase/decrease rate of each vehicle cost is less than −10%, the user using that vehicle is set to rank A, similarly, when the increase/decrease rate of each vehicle cost is −10% or more and less than −5%, the user using the vehicle is set to rank B, when the increase/decrease rate of each vehicle cost is −5% or more and less than 0%, the user of the vehicle using the vehicle is set to rank C, and when the increase/decrease rate of each vehicle cost is not reduced (when the increase/decrease rate is 0% or more), the user of that vehicle is set to rank D.

When there are a plurality of the users as in the case of the vehicle A in FIG. 7, the users (α, β) of the vehicle A have the same rank.

Subsequently, the CPU 20A determines the reward of each user in accordance with the rank (step S108).

Specifically, the CPU 20A acquires the reward rate of each rank stored in the setting information 120, the reduction cost (see FIG. 6) is multiplied by the reward rate so as to calculate (determine) the reward rate of each user. That is, the higher the rank, the higher the reward is determined to be. As described above, in the case of the rank D user, the reward rate is 0%, so there is no reward.

Next, the CPU 20A transmits the set rank (reward rate) of the set user and the calculated reduction cost to the terminal 30 of the user via the network N, and notifies the user (step S110).

As a result, each user can confirm their own rank and reduction cost by visually recognizing the rank and the reduction cost displayed on the terminal 30.

Effects

The user perceives their own rank by having a notification of their rank being sent from the center server 20 to the terminal 30. In addition, since the higher the rank, the higher the reward rate, the user will be motivated to move to the rank with the higher reward rate. That is, it is expected that each user will try to drive safely so that the operation cost of the vehicle (repair cost, damage compensation amount, etc.) can be suppressed, etc.

In this way, the business operator can reduce the total cost by make the users compete with each other.

In addition, since the reward of each user is calculated by multiplying the reduction cost of the business operator by the reward rate, the user becomes interested in the reduction cost of the entire business operator (company).

Thus, efforts will be made to increase the reduction cost not only for individual users but also for the entire business operator. For example, it is expected that the user advises other users on driving and maintenance, and proposes to the business operator regarding the reduction of the operation cost of the vehicle.

As a result, the business operator can further reduce the total cost.

Others

In the above embodiment, the group is the business operator and the member is the employee (driver). However, the present disclosure is not limited to this. For example, the configuration may be such that the group is the business operator and the members are business offices of the business operator, and may be such that each sales office receives a reward obtained by multiplying the reduction cost by the reward rate based on the contribution degree (rank) with respect to the reduction cost. Even in this case, in order to raise the rank, each sales office makes an effort to reduce the vehicle operation cost, and there is an effect that the total cost of the business operator is reduced.

Further, in the above embodiment, the CPU 20A is configured to read the total cost of the predetermined period from the total cost DB 110. However, the total cost may be calculated from the vehicle operating amount within the predetermined period.

Further, in the above embodiment, the reward rate is changed in accordance with the rank. However, the configuration may be such that a predetermined amount of the reward may be given in accordance with the rank (the higher the rank, the higher the price).

Alternatively, the configuration may be such that the reward of the user at the higher rank (for example, ranks A and B) is regarded as the reward (commission) obtained by multiplying the reduction cost by the predetermined reward rate, and the user at the lower rank (for example, ranks C and D) is regarded as a reward that is a predetermined amount (fixed amount). By doing so, the user is expected to make efforts to reduce the operation cost of the vehicle in for improving the rank in order to obtain the reward of the commission system.

Further, in the above embodiment, the reward is the amount obtained by multiplying the entire reduction cost by the reward rate. However, it may be the amount obtained by multiplying the predetermined ratio of the reduction cost by the reward rate. By limiting the resources of the reward to a part of the reduction cost, the reward of the user can be suppressed.

Further, in the above embodiment, the reward is set as an amount. However, the reward is not limited to this. For example, a configuration may be such that a discount coupon for repair or road service is given to the user.

Further, in the above embodiment, the operation cost of the vehicle is set as the insurance premium, the repair cost, and the damage compensation cost. However, other costs may be added to the operation cost of the vehicle, or any two or any one of them may be set as the operation cost of the vehicle.

Further, in the above embodiment, when the same vehicle is used by the plurality of users, the users are set to the same rank. However, the rank may be set individually. That is, by calculating the repair cost due to each individual user damaging the vehicle while driving the vehicle and the damage compensation amount due to the accident caused by each individual user, and the like as the vehicle operation cost for each user, The rank for each user may be set by obtaining the vehicle operation cost for each user and calculating the increase/decrease rate for each user.

Further, in the above embodiment, when calculating the reduction cost, the total cost of the predetermined period of the current year and the total cost of the same period of the previous year are compared. However, the period is not limited to the same period of the previous year as long as the period corresponds to the predetermined period. For example, the total cost of the fourth quarter may be compared with the total cost of the previous third quarter.

### REMARKS

It should be noted that various processors other than the CPU may execute the display process that is executed when the CPU 20A reads the software (program) in the above embodiment. Examples of the processors in this case include a programmable logic device (PLD) such as a field-programmable gate array (FPGA) for which a circuit configuration can be changed after production, a dedicated electric circuit that is a processor having a circuit configuration designed exclusively for executing a specific process, such as an application specific integrated circuit (ASIC), and the like. Further, each process described above may be executed by one of these various processors, or by a combination of two or more processors of the same type or different types (for example, a combination of FPGAs, a combination of a CPU and an FPGA, and the like). Further, the hardware structure of each of the various processors is, more specifically, an electric circuit in which circuit elements such as semiconductor elements are combined.

Further, in the above embodiments, a mode in which each program is stored (installed) in a non-transitory computer-readable recording medium (storage medium) in advance has been described. For example, the processing program 100 in the center server 20 is stored in the storage 20D in advance. However, the present disclosure is not limited to this, and the program may be recorded on a non-transitory recording medium (storage medium) such as a compact disc read-only memory (CD-ROM), a digital versatile disc read-only memory (DVD-ROM), and a universal serial bus (USB) memory to be provided. Further, the program may be downloaded from an external device via a network.

The flow of processes described in the above embodiments is an example, and unnecessary steps may be deleted, new steps may be added, or the process order may be changed within a range that does not deviate from the gist.

What is claimed is:

1. An information processing device comprising a processor,
wherein the processor includes
a calculation unit that obtains an operation cost of a vehicle in a first predetermined period in a group to which a plurality of members who uses the vehicle belong, and that calculates a reduction cost by which the operation cost of the vehicle in the first predetermined period is reduced compared to an operation cost of the vehicle in a second predetermined period that corresponds to the first predetermined period before the first predetermined period,
a setting unit that sets a rank in accordance with a reduction result of each of the members, and
a determination unit that determines a reward of each of the members based on the reduction cost in accordance with the rank of each of the members.

2. The information processing device according to claim 1, wherein the determination unit sets the reward to a predetermined amount corresponding to the reduction cost or a predetermined ratio of the reduction cost.

3. The information processing device according to claim 1, wherein the determination unit sets a reward of a member having a high rank to a predetermined ratio of the reduction cost and sets a reward of a member having a low rank to a predetermined amount.

4. The information processing device according to claim 1, further comprising a transmitting unit that transmits information of the rank of the member to a terminal of the member.

5. A reward determination method in which a computer executes processes comprising:
obtaining an operation cost of a vehicle in a first predetermined period in a group to which a plurality of members who uses the vehicle belong, and calculating a reduction cost by which the operation cost of the vehicle in the first predetermined period is reduced compared to an operation cost of the vehicle in a second predetermined period that corresponds to the first predetermined period before the first predetermined period;
setting a rank in accordance with a reduction result of each of the members; and
determining a reward of each of the members based on the reduction cost in accordance with the rank of each of the members.

6. A non-transitory storage medium that stores a reward determination program that causes a computer to execute processes comprising:
obtaining an operation cost of a vehicle in a first predetermined period in a group to which a plurality of members who uses the vehicle belong, and calculating a reduction cost by which the operation cost of the vehicle in the first predetermined period is reduced compared to an operation cost of the vehicle in a second predetermined period that corresponds to the first predetermined period before the first predetermined period;
setting a rank in accordance with a reduction result of each of the members; and
determining a reward of each of the members based on the reduction cost in accordance with the rank of each of the members.
